(19) United States
(12) Patent Application Publication
(10) Pub. No.: US 2007/0201764 A1
(43) Pub. Date: Aug. 30, 2007

(54) Apparatus and method for detecting key caption from moving picture to provide customized broadcast service

(75) Inventors: Cheol Kon Jung, Suwon-si (KR); Young Su Moon, Seoul (KR); Jin Guk Jeong, Suwon-si (KR); Ji Yeun Kim, Seoul (KR); Qifeng Liu, Beijing (CN)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/488,757

(22) Filed: Jul. 19, 2006

(30) Foreign Application Priority Data
Feb. 27, 2006 (KR) 10-2006-0018691

(51) Int. Cl. G06K 9/36

(52) U.S. Cl. 382/292

(57) ABSTRACT

An apparatus for detecting a caption from a moving picture, including: a caption domain detector selecting a candidate frame based on input genre information from an input moving picture and determining expectation caption domains from the selected candidate frame set; a target caption detector selecting target caption candidate domains based on repetition of a position or color pattern of the expectation caption domains and determining target caption domains based on a rate of change in a character or number domain from the selected target caption candidate domains; and a key caption detector detecting a key character or number information domain by analyzing the target caption domains.

### CROSS-REFERENCE TO RELATED APPLICATION

This application claims priority from Korean Patent Application No. 10-2006-0018691, filed on Feb. 27, 2006, in the Korean Intellectual Property Office, the disclosure of which is incorporated herein by reference.

### BACKGROUND OF THE INVENTION

1. Field of the Invention

The present invention relates to an apparatus and method for detecting a caption from a moving picture, and more particularly, to an apparatus and method for detecting a key caption from a moving picture to provide customized broadcast service.

2. Description of Related Art

There are many kinds of captions intentionally inserted in a moving picture by a content provider. However, a caption used for summarizing a moving picture or search is just a part of a displayed scene. The described caption is called a key caption. In this case, the key caption includes a target caption that is a standardized caption including key character information and a key caption domain that is a local caption domain including key information. Detecting the key caption from a moving picture is required in summarizing the moving picture, generating a highlight, and searching for a particular scene in the moving picture. For example, to easily and quickly replay and edit an article of a predetermined theme in a news program or a main scene in a sport game such as baseball, a key caption included in a moving picture can be used. Also, a customized broadcast service may be embodied by using a caption detected from a moving picture in a personal video recorder, a WiBro (Wireless Broadband) device, and a DMB (Digital Multimedia Broadcasting) phone.

In general methods of detecting a caption from a general moving picture, a domain showing positional repetition for a predetermined amount of time is determined and caption content is detected from a corresponding domain. For example, a domain whose positional repetition is dominant is determined from captions generated from thirty seconds and the same process is performed for several subsequent thirty seconds to accumulate information on the positional repetition for a predetermined amount of time, thereby selecting the target caption.

However, in the described conventional method, since the positional repetition of the target caption is detected from only a local time domain, reliability of caption detection is low. For example, the target caption such as a title of an anchor shot of news or sports game situation caption is to be detected, but an error of detecting a broadcasting company logo or advertisements having a similar form as the target caption, may occur. Consequently, key caption content such as a score or a ball count of a sport game is not reliably detected, thereby decreasing reliability.

Also, when a position of a target caption is changed, the target caption cannot be detected by the described conventional method. For example, since a position of a target caption is not fixed at a right, a left, a top and a bottom of a screen, and changes in real-time in a moving picture such as a golf game, probability of failing to detect a target caption only by using temporal position repetition of captions is high.

### SUMMARY OF THE INVENTION

Additional aspects and/or advantages of the invention will be set forth in part in the description which follows and, in part, will be apparent from the description, or may be learned by practice of the invention.

An aspect of the present invention provides an apparatus for detecting a caption to provide a customized broadcast service, which can detect robust key caption content from a target caption determined based on temporal position repetition or color pattern repetition of a caption from a moving picture.

An aspect of the present invention also provides a method of detecting a caption to provide customized broadcast service, in which a target caption is determined based on repetition of position or color pattern of a caption pattern in a caption domain determined from a candidate frame set of a moving picture so that corresponding caption content can be detected.

According to an aspect of the present invention, there is provided an apparatus for detecting a caption from a moving picture, including: a caption domain detector selecting a candidate frame based on input genre information from an input moving picture and determining expectation caption domains from the selected candidate frame set; a target caption detector selecting target caption candidate domains based on repetition of a position or color pattern of the expectation caption domains and determining target caption domains based on a rate of change in a character or number domain from the selected target caption candidate domains; and a key caption detector detecting a key character or number information domain by analyzing the target caption domains. However, the input genre information is not limited thereto. It can be other information.

The caption domain detector may include: a candidate frame selection unit selecting a relevant candidate frame set according to a genre indicated by the input genre information from the input moving picture; and a caption domain determination unit determining the expectation caption domains which may include a caption from the selected candidate frame set.

The target caption detector may include: a target caption candidate selection unit accumulating the detected expectation caption domains and selecting the accumulated expectation caption domains whose repeatability of the position or color pattern is larger than a threshold value, to be the target caption candidate domains; and a target caption determination unit determining the target caption domains by analyzing the rate of change in the character or number domain from the selected target caption candidate domains.

The key caption detector may detect the number information domain by using number information included in the target caption domains and may detect the character information domain by comparing character information included in the target caption domains with predetermined information with respect to the input moving picture from a predetermined database or web server.

According to another aspect of the present invention, there is provided an apparatus for detecting a caption from a moving picture, including: a target caption candidate selection unit obtaining representative color values of input moving picture patterns by using a predetermined color identification algorithm, and selecting domains corresponding to clusters having the representative color value larger than a predetermined threshold value as target caption candidate domains using pattern-modeling according to a clustering of the representative color values; and a target caption determination unit determining target caption domains by analyzing a rate of change in a key character or number domain from the selected target caption candidate domains, wherein character or number information domain is detected by analyzing the determined target caption domains.

According to still another aspect of the present invention, there is provided a method of detecting a caption from a moving picture, including: selecting a candidate frame based on input genre information from an input moving picture; determining expectation caption domains from the selected candidate frame set; selecting target caption candidate domains based on repetition of a position or color pattern of the expectation caption domains; determining target caption domains based on rate of change in a character or number domain from the selected target caption candidate domains; and detecting a key character or number information domain by analyzing the target caption domains.

According to yet another aspect of the present invention, there is provided a method of detecting a caption from a moving picture, including: obtaining representative color values of input moving picture patterns by using a predetermined color identification algorithm; pattern-modeling according to a clustering of the representative color values; selecting domains corresponding to clusters having the representative color value greater than a predetermined threshold value as target caption candidate domains from results of the pattern-modeling; determining target caption domains by analyzing a rate of change in a key character or number domain from the selected target caption candidate domains; and detecting a character or number information domain by analyzing the determined target caption domains.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a block diagram illustrating a key caption detection apparatus according to an embodiment of the present invention;

FIG. 2 is a flowchart illustrating a method of detecting a caption from a moving picture of news according to an embodiment of the present invention;

FIG. 3 is a diagram illustrating a caption domain and a key caption domain;

FIG. 4 is a flowchart illustrating a method of detecting a caption from a baseball game/soccer match moving picture;

FIG. 5 is a diagram illustrating a dual binarization method;

FIG. 6 is a diagram illustrating an example of the dual binarization method of FIG. 5 according to an embodiment of the present invention;

FIG. 7 is a diagram illustrating an operation of detecting a number domain by an OCR method;

FIG. 8 is a diagram illustrating a method of determining ball count of a baseball game from a number recognized for each domain;

FIG. 9 is a flowchart illustrating a method of detecting a caption from a golf match moving picture;

FIG. 10 is a diagram illustrating a position of a caption of a golf match moving picture, varying with a point in time;

FIG. 11 is a flowchart illustrating pattern modeling a target caption of FIG. 10; and

FIG. 12 is a diagram illustrating an operation of determining a character domain and a key caption domain by dual-binarizing a target caption domain.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

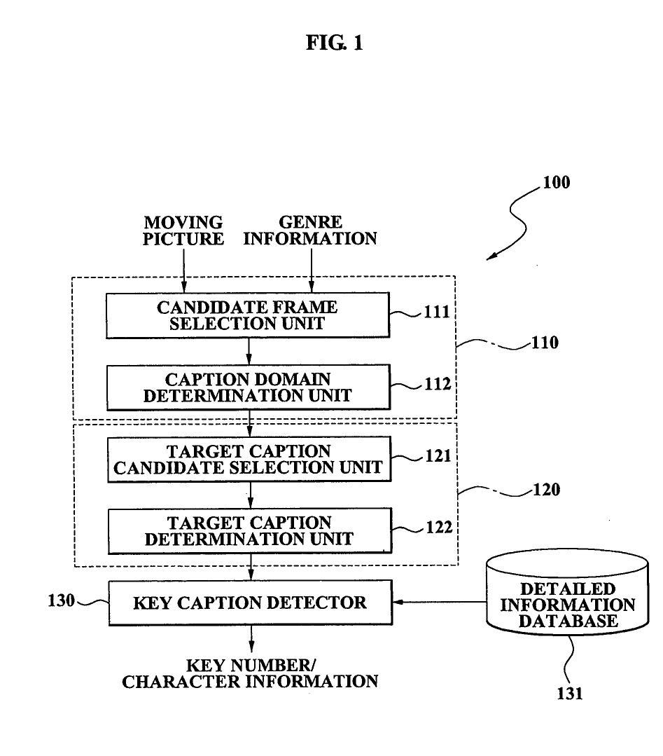

FIG. 1 is a diagram illustrating a key caption detection apparatus 100 according to an embodiment of the present invention. Referring to FIG. 1, the key caption detection apparatus 100 includes a caption domain detector 110, a target caption detector 120, a key caption detector 130, and a detailed information database 131.

Since the caption detection apparatus 100 determines a target caption based on a temporal position repetition and/or color pattern repetition of a caption pattern of an input moving picture, key number or character information may be detected from a robust and reliable key caption domain. Accordingly, when the caption detection apparatus 100 is applied to a personal video recorder (PVR), a WiBro device, a DMB phone, or a personal home server, summarizing a moving picture according to the robustly and precisely detected key caption content or searching a highlight may be easily performed, or customized broadcast service with respect to a scene corresponding to a requirement of a user may be stably embodied.

In this case, as described above, the target caption is a standardized caption including key character information of moving picture contents, such as a title caption of an anchor shot of news or a game information caption of sports. Also, the key caption domain is a local caption domain including respective key information of the target caption, such as a caption domain of a title of the anchor shot of news, a caption domain of inning/score/ball count of a baseball game, a caption domain of score of soccer match, or a player's caption domain of name/score of golf match, for example.

For this, the caption domain detector 110 receives moving picture data (hereinafter, referred to as a moving picture), genre information, and/or detects expectation caption domains. Namely, a candidate frame selection unit 111 included in the caption domain detector 110 selects a genre indicated by the input genre information, namely, a candidate frame set corresponding to news and sports, such as soccer, baseball, and golf, from the input moving picture. A caption domain determination unit 112 included in the caption domain detector 110 determines the expectation caption domains capable of including a caption, from the selected candidate frame set.

Accordingly, the target caption detector 120 selects target caption candidate domains based on repetition of a position or color pattern of the expectation caption domains and detects target caption domains based on a rate of change (RoC) in a character or number domain from the selected target caption candidate domains. Namely, a target caption candidate selection unit 121 in the target caption detector 120 accumulates the expectation caption domains and determines the domains whose repetition of the position or color pattern is greater than a threshold value as the target caption candidate domains. Also, a target caption determination unit 122 in the target caption detector 120 determines the target caption domains by analyzing the RoC in the character or number domain from the target caption candidate domains selected by the target caption candidate selection unit 121.

When the target caption detector 120 detects the target caption domains, the key caption detector 130 detects a character or number information domain by analyzing the target caption domains. In this case key caption detector 130 may detect the number information domain by using number information in the target caption domains and may detect the character information domain by comparing character information in the target caption domains and detailed information with respect to the input moving picture stored in the detailed information database 131. In the detailed information database 131, the detailed information of a corresponding genre of the input moving picture may be game information indicating a player's name in a sports game, or between what teams a game is being played, but not restricted thereto. In this case, the key caption detector 130 may refer to the detailed information of the detailed information database 131 and also receive the detailed information of the corresponding genre from a PVR, a WiBro device, a DMB phone, or a web server coupled with/to a personal home server.

Hereinafter, detailed operations of the caption detection apparatus 100 will be described for each genre.

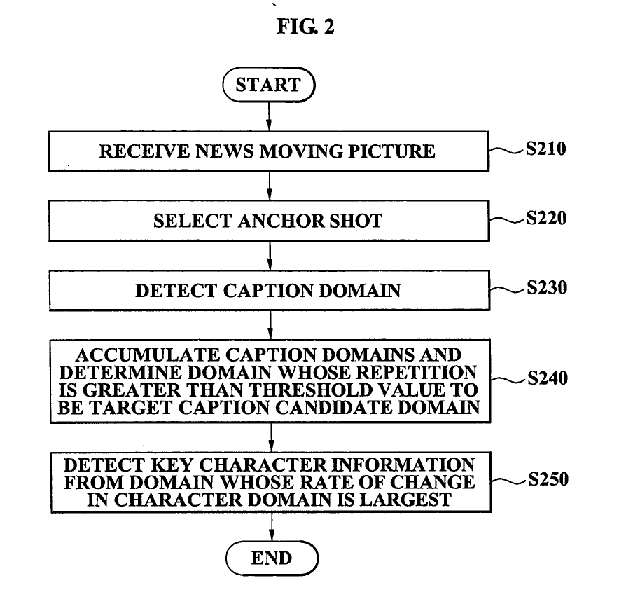

FIG. 2 is a flowchart illustrating a method of detecting a caption from a moving picture of news according to an embodiment of the present invention. The candidate frame selection unit 111 of FIG. 1 receives a news moving picture (S210). In this case, corresponding genre information, in this example, news information may be inputted by a user or may be used by being extracted from a moving picture according to an electronic program guide (EPG) of a user terminal. When receiving the news moving picture, the candidate frame selection unit 111 may select an anchor shot as a candidate frame set according to the corresponding genre (S220). Namely, a predetermined frame set of a part showing a scene of an anchor shot, from which a key caption may be easily obtained for summarizing a moving picture, may be selected as the candidate frame set. To obtain the anchor shot from the input moving picture, a method of using a template, a method of using clustering method, a method of using multimodal method, and a method disclosed in Korean Patent Publication No. 10-2005-0087987 (Sep. 1, 2005) may be used. Since the described anchor shot obtainment method is beyond the scope of the present invention, the detailed description will be omitted.

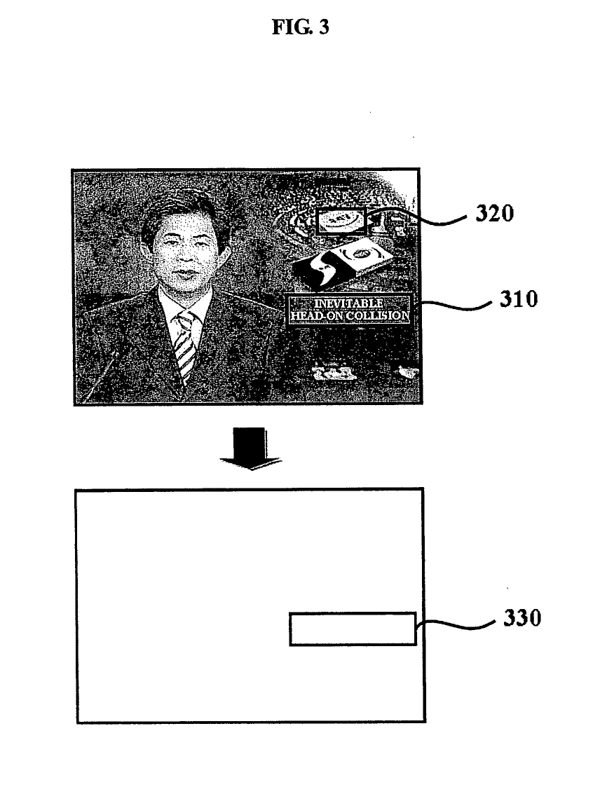

On the other hand, when the anchor shot is selected as the candidate frame set, the caption domain determination unit 112 determines expectation caption domains 310 and 320 which may include a caption, from the anchor shot, as shown in FIG. 3 (S230). Methods of detecting the domains which may include a caption may be performed in a compressed domain or a uncompressed domain of moving picture data or a method as disclosed in Korean Patent Publication No. 10-2005-0082223 (Aug. 23, 2005) may be used. Since the expectation caption determination method is beyond the scope of the present invention, detailed description will be omitted.

Accordingly, the target caption candidate selection unit 121 of FIG. 1 accumulates the expectation caption domains detected by the caption domain detector 110 and determines the accumulated domains, whose repetition of the position or color pattern is greater than a threshold value, as the target caption candidate domains (S240). For example, as shown in FIG. 3, since the expectation caption domain 310 that is the part indicating a title of a related article is estimated to have higher repetition than the expectation caption domain 320 that is a character part of a temporary scene, the target caption candidate selection unit 121 determines the expectation caption domain 310 to be a target caption candidate domain 330.

When the target caption candidate domain 330 is determined, the target caption determination unit 122 analyzes an RoC in a character domain from the target caption candidate domain 330 and determines the domain whose RoC is greatest, to be a target caption domain. In this case, since the target caption candidate domain 330 includes a key caption regardless of a character or number, the key caption detector 130 may consider the target caption domain as a key caption domain and may extract character or number information from the corresponding domain (S250).

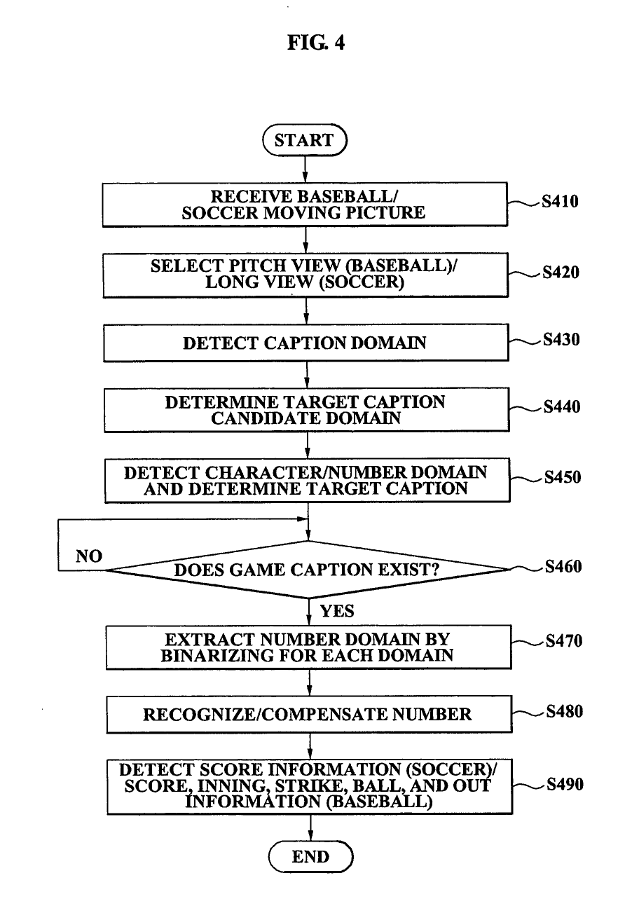

FIG. 4 is a flowchart illustrating a method of detecting a caption from a baseball game/soccer match moving picture. The candidate frame selection unit 111 of FIG. 1 receives a baseball game or soccer match moving picture (S410). In this case, corresponding genre information, namely, information of baseball/soccer may be inputted by a user or may be extracted from the moving picture according to an EPG of a user terminal to be used. When receiving the baseball game/soccer match moving picture, according to the corresponding genre, the candidate frame selection unit 111 may select a pitch view in the case of the baseball game or may select a long view in the case of the soccer match, as a candidate frame set (S420). Namely, to summarize the moving picture, a predetermined frame set of a part including the pitch view of a baseball game, from which key game information such as names of playing teams, score, and strike, ball, and out count may be easily obtained, or a predetermined frame set of a part including a long view of soccer match may be selected as the candidate frame set. To obtain the pitch view or long view from the input moving picture, methods disclosed in Korean Patent Applications Nos. 102005-0088235 and No. 10-2004-005903 may be used, and other methods using a predetermined algorithm may be used.

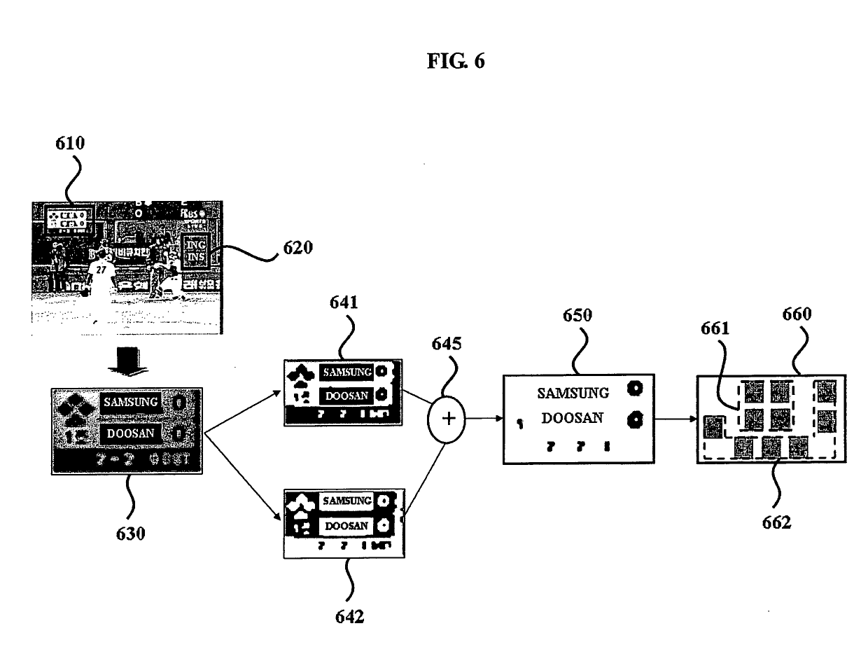

On the other hand, as described above, when the pitch view (or long view) is selected as a candidate frame set, as shown in FIG. 6, the caption domain determination unit 112 determines expectation caption domains 610 and 620 which may include a caption, from the candidate frame set (S430). The domains which can include a caption may be detected similarly to the method described with reference to FIG. 2.

Therefore, the target caption candidate selection unit 121 of FIG. 1 accumulates the expectation caption domains detected by the caption domain detector 110 and determines the accumulated domains whose repetition of a position is greater than a threshold value as the target caption candidate domains (S440). For example, as shown in FIG. 6, since the expectation caption domain 610 that is a part indicating key game information is estimated to have repetition more than the expectation caption domain 620 that is a temporary advertisement part, the target caption candidate selection unit 121 determines the expectation caption domain 610 to be a target caption candidate domain 630.

When the target caption candidate domain 630 is determined, the target caption determination unit 122 analyzes an RoC of a character or number domain from the target caption candidate domain 630 and determines the domain whose RoC is greatest, to be a target caption domain (S450).

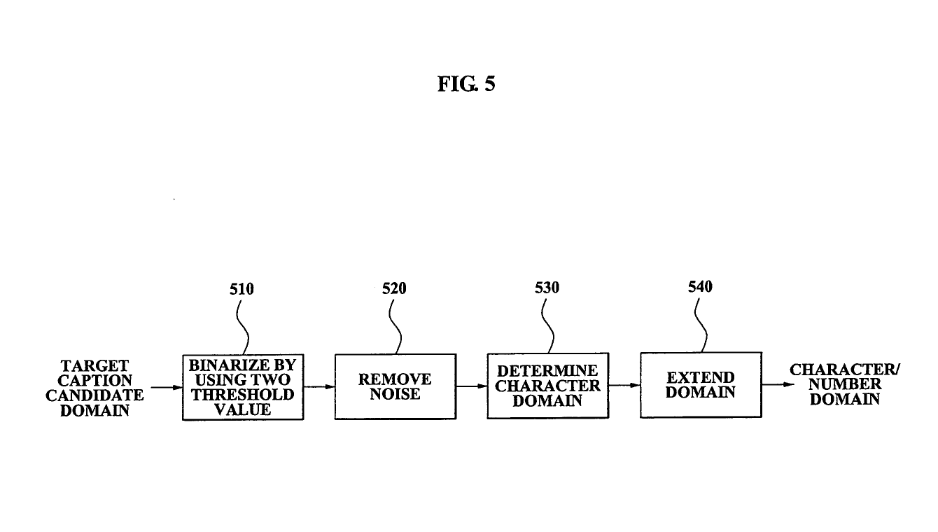

In this case, the target caption determination unit 122 may extract the character or number domain from the selected target caption candidate domain 630 by using dual binarization. The dual binarization is a method of easily detecting a character or number domain having black and white colors inverted with each other. As shown in FIG. 5, according to two threshold values which can be determined by an Otsu method, for example, a first threshold value (TH1) and a second threshold value (TH2), the target caption candidate domain 630 is binarized (510). The target caption candidate domains 630 may be binarized into two images 641 and 642 of FIG. 6. For example, in the target caption candidate domains 630, when a brightness value of a pixel is greater than the TH1, the brightness value is changed into 0, and when the brightness value of the pixel is not greater than the TH1, the brightness value is changed into a maximum brightness value, for example, 255 in the case of 8 bit data, thereby obtaining the image 641. Also, in the target caption candidate domains 630, when the brightness value of the pixel is less than the TH2, the brightness value is changed into 0, and when the brightness value of the pixel is not less than the TH2, the brightness value is changed into a maximum brightness value, thereby obtaining the image 642.

As described above, after the target caption candidate domains 630 are binarized, noise is removed by an interpolation method or algorithm (520). The binarized images 641 and 642 are combined to determine a domain 650 by a unit 645 (530). The determined domain 650 as described above is scaled into a suitable scale, and a desired character or number domain 660 may be obtained.

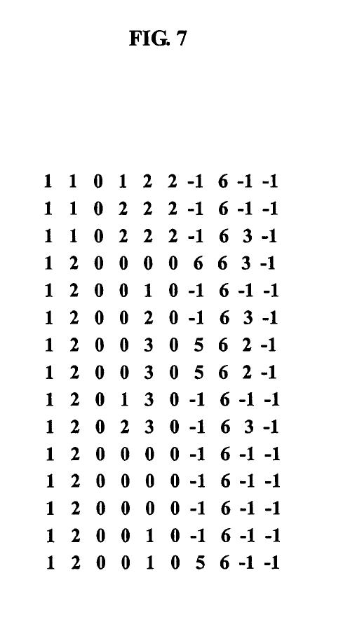

When the desired character or number domain 660 is determined according to the dual binarization, the target caption determination unit 122 divides the domain 660 into a character domain 661 and a number domain 662 by using optical character recognition (OCR) and determines a number domain by analyzing a RoC of the divided character and number domain. When a result of recognizing the character domain 661 and the number domain 662 according to the OCR method is shown as in FIG. 7, a part of a negative value may indicate the character domain 661 and a part of a positive value may indicate the number domain 662. Thus, according to an RoC of intensity of the number domain 662, the target caption determination unit 122 determines a domain whose RoC is greatest, as a target caption domain (S450). In this case, a black part of the number domain 662 of FIG. 6 is assumed to be the target caption domains.

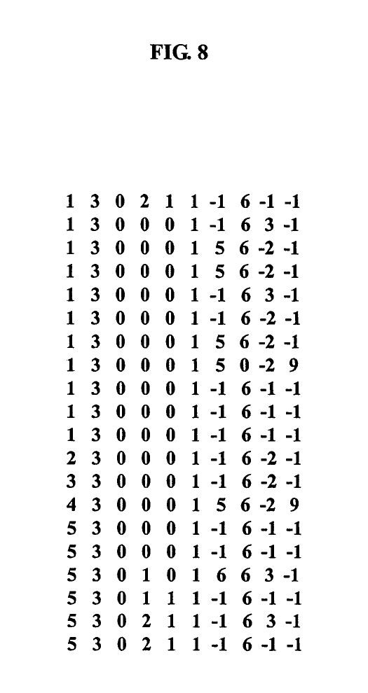

As described above, when the target caption domains are detected, the key caption detector 130 detects number information by analyzing the target caption domains (S460 through S490). When a target caption, namely, a caption indicating game information exists in the character domain 661 (S460), the key caption detector 130 extracts the number domain by using the dual binarization for each domain of the black part for each domain 662 (refer to S450) and recognizes a number by precisely analyzing the RoC of the extracted number domain (S470 and S480). In this case, the key caption detector 130 may compensate the recognized number by continuity and may detect a corresponding key number from a corresponding key number information domain by using the compensated number (S480). For example, in a result of an OCR method according to time as shown in FIG. 8, when a number having a completely different value is shown between two numbers, the number is processed as a mid value between the two values, or when a number does not exist or is processed as a character to be shown as omitted, a corresponding part may be compensated by using continuity between the two numbers. For example, when there is no number between “1” and “1”, a number between two numbers may be determined to be “1”.

Accordingly, in the case of soccer, the key caption detector 130 may determine a score domain that is a corresponding key number information domain and may extract corresponding score information. In the case of baseball, the key caption detector 130 may determine a score domain, an inning domain, a strike count domain, a ball count domain, and/or an out count domain, which are corresponding key number information domains, and may extract corresponding game information (S490). In this case, to determine the strike count domain and the ball count domain, a corresponding domain where 3 is frequently shown in FIG. 8 may be the ball count domain and a right or left side of the ball count domain may be determined to be the strike count domain. Also, a third domain which is to a right or left side of the strike count domain and the ball count domain, may be the out count domain. Also, the score domain may be two domains which have a size similar to each other and are located in a position vertical or horizontal to each other. Also, when the out count domain is changed as time passes, a domain in which a number is increased may be determined to be the inning domain.

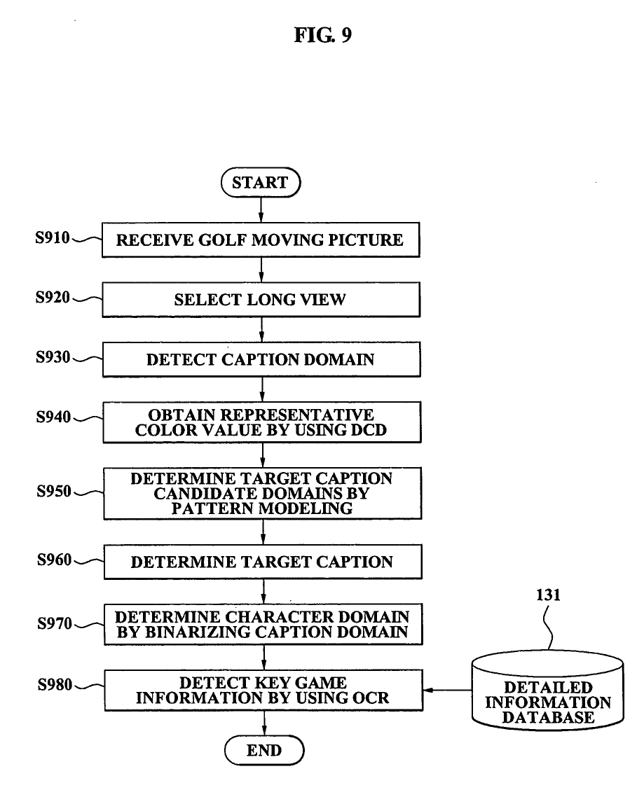

FIG. 9 is a flowchart illustrating a method of detecting a caption from a golf match moving picture. The candidate frame selection unit 111 of FIG. 1 receives the golf match moving picture (S910). In this case, corresponding genre information, namely, golf information may be inputted by a user or may be extracted from the moving picture from a user terminal according to an EPG to be used. When receiving the golf match moving picture, the candidate frame selection unit 111 may select a long view as a candidate frame set according to a corresponding genre as the cases of baseball and soccer (S920).

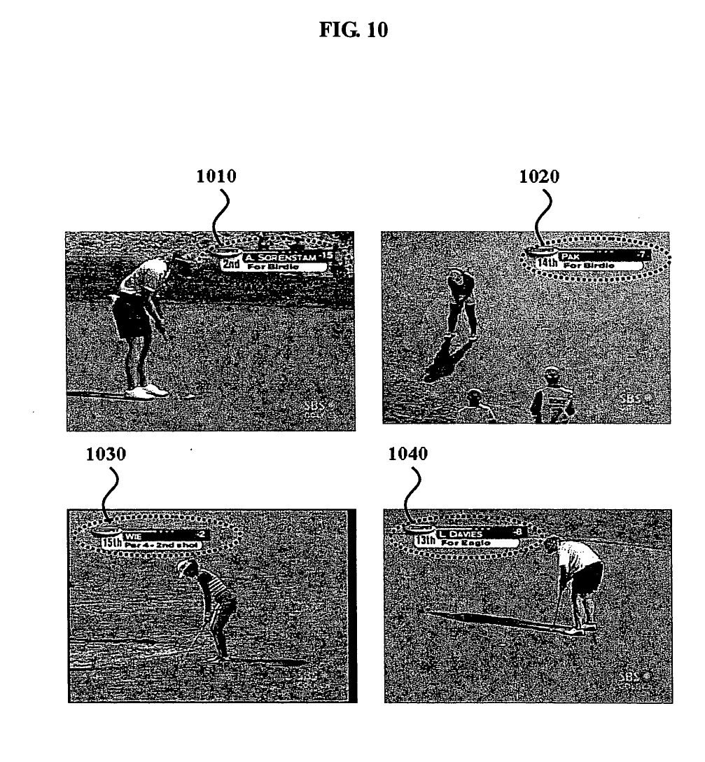

On the other hand, when the long view is selected as the candidate frame set as described above, the caption domain determination unit 112 determines expectation caption domains 1010 through 1040 which may include a caption, from the candidate frame set, as shown in FIG. 10 (S930). The domains which may include a caption may be detected similarly to the method described with reference to FIG. 2.

In the case of golf, since a position of a target caption may be changed in temporarily changed long views, target caption candidate domains are determined by using repetition of a color pattern, and repetition of temporal position is not used. Namely, the target caption candidate selection unit 121 of FIG. 1 accumulates the expectation caption domains detected by the caption domain detector 110 and determines the accumulated domains whose repetition of the color pattern is greater than a threshold value as the target caption candidate domains (S940 and S950).

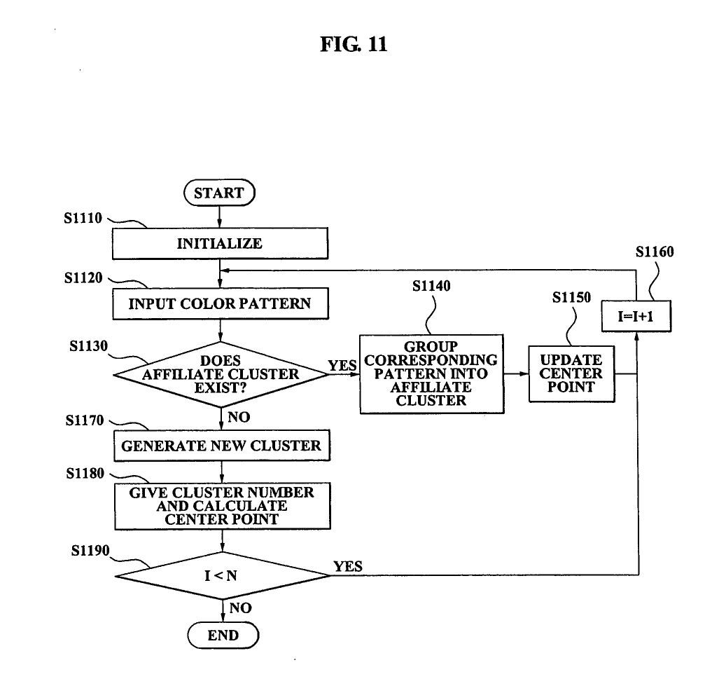

For example, the target caption candidate selection unit 121 may obtain representative color values of the accumulated expectation caption domains by using an image descriptor for identifying color, such as a dominant color descriptor (DCD) (S940). The target caption candidate selection unit 121 may determine target caption candidate domains by clustering the representative color values to be grouped according to a pattern modeling process shown in FIG. 11 (S950).

In the pattern modeling process shown in FIG. 11, a cluster number, 1, for example, is given to an initial representative color value obtained in initialization and a center point (coordinates) of a corresponding cluster is stored together with a number 1 of a pattern (color value) grouped into an affiliate cluster (S1110). When a color pattern is inputted (S1120), whether an affiliate cluster corresponding to the representative color value obtained by the DCD exists is determined (S1130). In this case, to determine whether the representative color value is corresponding to the affiliate cluster, whether the representative color value is included in a predetermined range of an average of total colors of the affiliate cluster may be determined. For example, whether predetermined distance information between colors is corresponding to the affiliate cluster may be determined by using Euclidean metric algorithm.

In operation S1130, when the distance information between colors corresponds to the affiliate cluster, the representative color value is clustered into the same group, a corresponding center point is updated, a number of grouped patterns is increased by 1, and the same process is performed with respect to a subsequent index (S1140 through S1160)

In operation S1130, when the distance information between colors dose not correspond to the affiliate cluster, the representative color value is clustered into a different group, another cluster number, 2, for example, is given, and a center point is calculated and stored (S1170 and S1180). The described process is performed until an index i becomes equal to a maximum number of input patterns N (S1190).

According to the process shown in FIG. 11, clusters whose grouped representative color values are more than a predetermined number may be selected and the target caption candidate domains may be determined by comparing the selected clusters with a predetermined threshold value (S950). For example, the target caption candidate selection unit 121 may select domains corresponding to the clusters having the representative color values greater than the predetermined threshold value, as the target caption candidate domains.

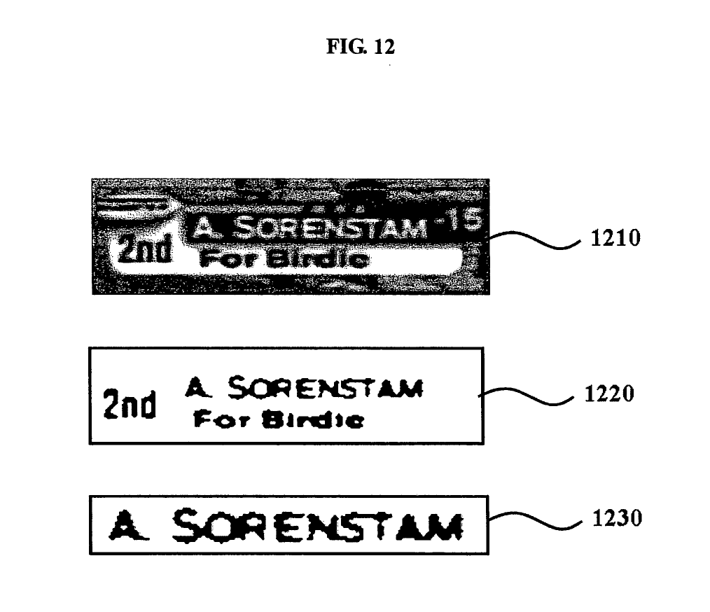

When the target caption candidate domains are determined as described above, the target caption determination unit 122 analyzes an RoC of a character or number domain and determines a domain whose RoC is greatest, to be a target caption domain from the target caption candidate domains, for example, a target caption domain 1210 of FIG. 12, as shown in FIG. 4 (S960).

As described above, when the target caption domains are detected, the key caption detector 130 detects key caption information by analyzing the target caption domains (S960 through S980). The key caption detector 130 extracts the character or number domain by using dual binarization for each domain (refer to S450) with respect to the target caption domains as a dual binarized target caption domain 1220 of FIG. 12 and determines a key character or number domain by precisely analyzing the RoC of the character or number domain by using OCR (refer to S450).

Accordingly, the key caption detector 130 may extract corresponding score information from a score domain that is a corresponding key number domain and may extract corresponding information with respect to names of players and names of teams from names of players and names of teams domains which are corresponding key character domains (refer to an extracted name 1230). In this case, as described above, game information such as the information with respect to names of players and names of teams may be determined to be a key caption domain with respect to names of players and names of teams only when being matched with detailed information with respect to the inputted moving picture, stored in the detailed information database 131 or a predetermined web server.

As described above, in the caption detection apparatus 100 according to an embodiment of present invention, the caption domain detector 110 selects a candidate frame set such as an anchor shot, a pitch view, and/or a long view from an input moving picture with reference to input genre information and determines expectation caption domains which may include a caption. Also, the target caption detector 120 selects target caption candidate domains which may be a target caption, based on repetition of a position, or a color pattern of the expectation caption domains, and determines target caption domains based on a RoC of a character or number domain. Accordingly, the key caption detector 130 detects a key character or number information domain by analyzing the target caption domains.

As described above, in the caption detection apparatus and method according to an embodiment of the present invention, since a target caption is determined based on temporal position repetition or color pattern repetition of a moving picture caption pattern, robust key caption content may be detected. Accordingly, in a PVR, a WiBro device, a DMB phone, or a personal home server, a summary of a moving picture and highlight search may be precisely provided or a customized broadcast service with respect to a desired scene requested by a user may be reliably embodied.

The caption detection method according to the present invention may be embodied as a program instruction capable of being executed via various computer units and may be recorded in a computer-readable recording medium. The computer readable medium may include a program instruction, a data file, and a data structure, separately or cooperatively. The program instructions and the media may be those specially designed and constructed for the purposes of the present invention, or they may be of the kind well-known and available to those skilled in the art of computer software arts. Examples of the computer-readable media include magnetic media (e.g., hard disks, floppy disks, and magnetic tapes), optical media (e.g., CD-ROMs or DVD), magneto-optical media (e.g., optical disks), and hardware devices (e.g., ROMs, RAMs, or flash memories, etc.) that are specially configured to store and perform program instructions. The media may also be transmission media such as optical or metallic lines, wave guides, etc. including a carrier wave transmitting signals specifying the program instructions, data structures, etc. Examples of the program instructions include both machine code, such as produced by a compiler, and files containing high-level language codes that may be executed by the computer using an interpreter. The hardware elements above may be configured to act as one or more software modules for implementing the operations of this invention.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An apparatus for detecting a caption from a moving picture, comprising:
a caption domain detector selecting a candidate frame set from the moving picture based on a genre information and determining expectation caption domains from the selected candidate frame set;
a target caption detector selecting target caption candidate domains based on color pattern of the expectation caption domains and determining target caption domains based on a rate of change in a character and/or number domain from the selected target caption candidate domains; and
a key caption detector detecting a key character and/or number information domain by analyzing the target caption domains.

2. The apparatus of claim 1, the target caption detector selecting target caption candidate domains based on a position of the expectation caption domains.

3. The apparatus of claim 1, further comprising:
a detailed information database storing detailed information of genre of the moving picture.

4. The apparatus of claim 3, wherein the key caption detector detecting the number information and/or character information based on the detailed information from the detailed information database.

5. The apparatus of claim 1, wherein the genre information is received from any of a PVR (Personal Video Recorder), an WiBro device, a DMB phone, and a web server coupled with a personal home server.

6. The apparatus of claim 1, wherein the caption domain detector comprises:
a candidate frame selection unit selecting a relevant candidate frame set according to a genre indicated by the genre information; and
a caption domain determination unit determining the expectation caption domains which include a caption from the selected candidate frame set.

7. The apparatus of claim 6, wherein the candidate frame selection unit selects any one of an anchor shot of news, a pitch view of baseball field, and a long-distance view image of soccer or golf field, as the candidate frame set.

8. The apparatus of claim 1, wherein the target caption detector comprises:
a target caption candidate selection unit accumulating the detected expectation caption domains and selecting the accumulated expectation caption domains whose repeatability of the color pattern is larger than a threshold value, to be the target caption candidate domains; and
a target caption determination unit determining the target caption domains by analyzing the rate of change in the character or number domain from the selected target caption candidate domains.

9. The apparatus of claim 8, wherein the target caption candidate selection unit obtains representative color values of the accumulated expectation caption domains by using a predetermined color identification algorithm, and selects the domains corresponding to clusters having a representative color value larger than the threshold value as target caption candidate domains using pattern-modeling according to a clustering of the representative color values.

10. The apparatus of claim 9, wherein the pattern-modeling comprises:
determining whether the representative color value is corresponding to an affiliate cluster in a predetermined range;
clustering representative color values corresponding to the affiliate cluster to a same group and updating a relevant center point;
clustering representative color values which are not corresponding to the affiliate cluster, to another group, and calculating and storing the relevant center point.

11. The apparatus of claim 9, wherein the clusters based on a number of the groups of the representative color values are selected, and the selected clusters are compared with the threshold value.

12. The apparatus of claim 8, wherein the target caption determination unit extracts the character or number domain from the selected target caption candidate domains by using dual binarization, determines the number domain by analyzing the rate of change of the extracted character or number domain by using a predetermined character recognition algorithm, and determines the target caption domains according to a rate of change in brightness of the determined number domain.

13. The apparatus of claim 1, wherein the key caption detector detects the number information domain by using number information included in the target caption domains and detects the character information domain by comparing character information included in the target caption domains with predetermined information with respect to the input moving picture from a predetermined database or web server.

14. The apparatus of claim 13, wherein the key caption detector extracts a number domain by using dual binarization for each of the detected number information domains when a target caption exists in the character information domain and recognizes a number by analyzing the rate of change in the extracted number domain by using the predetermined character recognition algorithm.

15. The apparatus of claim 14, wherein the key caption detector compensates for the recognized number by using continuity and detects a relevant key number by determining a key number information domain using the compensated number.

16. The apparatus of claim 14, wherein the dual binarization comprises:
generating two binarized images by binarizing an input image to black and white colors inverted with each other according to each of two predetermined threshold values;
removing noise from the two binarized images according to a predetermined algorithm;
determining predetermined domains by compositing the two binarized images from which the noise is removed; and
obtaining a corresponding information domain by enlarging the determined domains to a predetermined size.

17. An apparatus for detecting a caption from a moving picture, comprising:
a target caption candidate selection unit obtaining representative color values of input moving picture patterns by using a predetermined color identification algorithm, and selecting domains corresponding to clusters having the representative color value larger than a predetermined threshold value as target caption candidate domains using pattern-modeling according to a clustering of the representative color values; and
a target caption determination unit determining target caption domains by analyzing a rate of change in a key character or number domain from the selected target caption candidate domains,
wherein character or number information domain is detected by analyzing the determined target caption domains.

18. The apparatus of claim 17, wherein the pattern-modeling comprises:
determining whether the representative color value is corresponding to an affiliate cluster in a predetermined range;
clustering representative color values corresponding to the affiliate cluster to a same group and updating a relevant center point;
clustering representative color values which are not corresponding to the affiliate cluster, to another group, and calculating and storing the relevant center point.

19. A method of detecting a caption from a moving picture, comprising:
selecting a candidate frame set from the moving picture based on a genre information;
determining expectation caption domains from the selected candidate frame set;
selecting target caption candidate domains based on repetition of color pattern of the expectation caption domains;
determining target caption domains based on a rate of change in a character or number domain from the selected target caption candidate domains; and
detecting a key character or number information domain by analyzing the target caption domains.

20. The method of claim 19, wherein the candidate frame set is any one of an anchor shot of news, a pitch view of baseball field, and a long-distance image of soccer or golf field.

21. The method of claim 19, wherein the expectation caption domains are accumulated and the accumulated expectation caption domains whose repeatability of the color pattern is greater than a threshold value are selected to be the target caption candidate domains.

22. The method of claim 21, further comprising:
obtaining representative color values of the accumulated expectation caption domains by using a predetermined color identification algorithm;
pattern-modeling according to a clustering of the representative color values; and
selecting domains corresponding to clusters having the representative color value greater than the predetermined threshold value as target caption candidate domains from results of the pattern-modeling.

23. The method of claim 22, wherein the pattern-modeling comprises:
determining whether the representative color value is corresponding to an affiliate cluster in a predetermined range;
clustering representative color values corresponding to the affiliate cluster to a same group and updating a relevant center point;
clustering representative color values which are not corresponding to the affiliate cluster to another group, and calculating and storing the relevant center point.

24. The method of claim 22, wherein the clusters based on a number of the groups of the representative color values are selected and the selected clusters are compared with the threshold value.

25. The method of claim 19, further comprising:
extracting the character or number domain from the selected target caption candidate domains by using dual binarization;
determining the number domain by analyzing the rate of change of the extracted character or number domain by using a predetermined character recognition algorithm; and
determining the target caption domains according to rate of change in brightness of the determined number domain.

26. The method of claim 19, further comprising:
detecting the number information domain by using number information included in the target caption domains; and
detecting the character information domain by comparing character information included in the target caption domains with predetermined information with respect to the input moving picture from a predetermined database or web server.

27. The method of claim 26, further comprising:
performing dual binarization for each of the detected number information domains when a target caption exists in the character information domain;
extracting the number domain from the dual binarization; and
recognizing a number by analyzing the rate of change in the extracted number domain by using the predetermined character recognition algorithm.

28. The method of claim 27, further comprising:
compensating for the recognized number by using continuity; and
detecting a relevant key number by determining a key number information domain using the compensated number.

29. The method of claim 27, the dual binarization comprises:
generating two binarized images by binarizing an input image to black and white colors inverted with each other according to each of two predetermined threshold values;
removing noise from the two binarized images according to a predetermined algorithm;
determining predetermined domains by compositing the two binarized images from which the noise is removed; and
obtaining a corresponding information domain by enlarging the determined domains to a predetermined size.

30. A method of detecting a caption from a moving picture, comprising:
obtaining representative color values of input moving picture patterns by using a predetermined color identification algorithm;
pattern-modeling according to a clustering of the representative color values;
selecting domains corresponding to clusters having the representative color value greater than a predetermined threshold value as target caption candidate domains from results of the pattern-modeling;
determining target caption domains by analyzing a rate of change in a key character or number domain from the selected target caption candidate domains; and
detecting a character or number information domain by analyzing the determined target caption domains.

31. The method of claim 30, wherein the pattern-modeling comprises:
determining whether the representative color value is corresponding to an affiliate cluster in a predetermined range;
clustering representative color values corresponding to the affiliate cluster to a same group and updating a relevant center point;
clustering representative color values not corresponding to the affiliate cluster to another group, and calculating and storing the relevant center point.

32. A method of detecting a caption from a moving picture, comprising:
selecting a candidate frame set from the moving picture based on information;
determining expectation caption domains from the selected candidate frame set;
selecting target caption candidate domains based on repetition of color pattern of the expectation caption domains;
determining target caption domains based on a rate of change in a character and/or number domain from the selected target caption candidate domains; and
detecting a key character and/or number information domain by analyzing the target caption domains.

33. The method of claim 32, wherein the information is genre information.
